(19) United States
(12) Patent Application Publication
(10) Pub. No.: US 2015/0149389 A1
(43) Pub. Date: May 28, 2015

(54) ELECTRICITY LOAD MANAGEMENT DEVICE AND ELECTRICITY LOAD MANAGEMENT METHOD THEREOF

(71) Applicant: Institute For Information Industry, Taipei (TW)

(72) Inventors: Hsin-Pu CHUNG, Taipei City (TW); Jen-Chih WANG, Nantou City (TW); Dze-Min JOU, Taipei City (TW); Wei-Sen LIN, Erlun Township (TW); Chia-Wei TSAI, Tainan City (TW)

(73) Assignee: Institute For Information Industry, Taipei (TW)

(21) Appl. No.: 14/100,939

(22) Filed: Dec. 9, 2013

(30) Foreign Application Priority Data
Nov. 26, 2013 (TW) 102142961

(51) Int. Cl. G06Q 30/02

(52) U.S. Cl. CPC G06Q 30/0283; G06Q 50/06
USPC 705/412

(57) ABSTRACT

An electricity load management device and an electricity load management method thereof are provided. The electricity load management device is connected to a plurality of data centers via a network. Each of the data centers comprises at least one server. For each data center, the electricity load management device allocates a plurality of data allocation percents of a plurality of service requests sequentially according to a schedule so as to receive a piece of electricity consumption information from each data center. The electricity load management device creates a cost profile of each data center according to the electricity consumption information of each data center, and determines an electricity load allocation percent of each data center according to the cost profiles and the electricity charge information. Finally, the electricity load management device allocates the subsequent service requests to the data centers according to the electricity load allocation percents.

### PRIORITY

This application claims the benefit of priority based on Taiwan Patent Application No. 102142961 filed on Nov. 26, 2013, which is hereby incorporated herein by reference in its entirety.

### FIELD

The present invention relates to an electricity load management device and an electricity load management method thereof. More particularly, the electricity load management device of the present invention allocates a plurality of percents of service requests to a plurality of data centers connected to the electricity load management device so that a related cost for processing the percents of the service requests by each of the data centers is estimated and allocates the subsequent service requests to the data centers according to the relating costs.

### BACKGROUND

With rapid development of the Internet, network service providers have established data centers widely in different areas to provide various enterprises with cloud services. Usually a network service provider deploys a portal server to receive service requests from the Internet and allocate the service requests to a plurality of date centers for processing. To guarantee the quality of service (QoS), an enterprise usually signs a contract with the network service provider in terms of the QoS requirements which, for example, require that the service response time must be within the specified time.

In such a case, if the actual service response time exceeds the service response time specified in the contract, then the network service provider has to pay the enterprise a QoS default penalty. Accordingly, most mechanisms currently used to allocate service requests to data centers take only the capability of satisfying the specified QoS requirements into consideration to avoid the QoS default penalty. However, for the network service provider, the electricity consumption of the data centers is one of the main parts of the expenditure. Therefore, the electricity consumption also needs to be taken into consideration in order to control the cost for operating each data center effectively.

In detail, to ensure the power-supply security of the electric power system, electric power companies in the area where the data centers are located usually sign contracts on electricity consumption with the network service provider to specify the maximum electricity consumption power (kilowatt; KW) and the maximum electricity consumption demand (kilowatt hour; KWH) of the data centers. The electricity consumption power and the electricity consumption demand usually increase with the number of the service requests to be processed by the data center. Therefore, if the electricity consumption power and the electricity consumption demand exceed the value specified by the contract, then the network service provider will pay an overuse extra charge. Furthermore, when the number of service requests to be processed by the data center increases, the data center needs to take more time to process the service requests allocated to it, which results in a longer service response time. Consequently, the network service provider has to pay the QoS default penalty.

Accordingly, an urgent need exists in the art to provide an electricity load management mechanism capable of taking the basic electricity charge, the overuse extra charge and the QoS default penalty into consideration simultaneously to allocate service requests to each data center so that the electricity consumption-related cost of all the data centers can be controlled effectively.

### SUMMARY

An objective of certain embodiments of the present invention is to provide an electricity load management mechanism, which allocates a plurality of percents of service requests received to a data center to make statistics on electricity consumption information generated during the data center processes the percents of the service requests so that a basic electricity charge, an overuse extra charge and a QoS default penalty can be estimated. In this way, an electricity load allocation percent of the service requests to be allocated to each of the data centers can be determined based on the estimation results so that the electricity consumption-related cost of the entire data center can be controlled effectively.

To achieve the aforesaid objective, certain embodiments of the present invention comprises an electricity load management device, which comprises a network interface, a storage and a processor. The network interface is connected to a plurality of data centers via a first network. Each of the data centers comprises at least one server. The storage is configured to record a piece of electricity charge information of each of the data centers. Each of the pieces of electricity charge information comprises a basic electricity charge rate, an overuse extra charge and a quality of service (QoS) default penalty. The processor electrically connected to the network interface and the storage is configured to execute the following steps of: (a) receiving a plurality of service requests from a second network via the network interface; (b) for each of the data centers, allocating a plurality of data allocation percents of the service requests sequentially according to a schedule so as to receive a piece of electricity consumption information from each of the data centers and store the pieces of electricity consumption information into the storage; (c) creating a cost profile for each of the data centers according to the pieces of electricity consumption information; (d) determining an electricity load allocation percent of each of the data centers according to the cost profiles and the pieces of electricity charge information; and (e) allocating the subsequent service requests to the data centers according to the electricity load allocation percents.

The present invention in certain embodiments of further comprises an electricity load management method for use in an electricity load management device. The electricity load management device comprises a network interface, a storage and a processor. The network interface is connected to a plurality of data centers via a network. Each of the data centers comprises at least one server. The storage records a piece of electricity charge information of each of the data centers. Each of the pieces of electricity charge information comprises a basic electricity charge rate, an overuse extra charge and a QoS default penalty. The processor is electrically connected to the network interface and the storage. The electricity load management method is executed by the processor and comprises the following steps of: (a) receiving a plurality of service requests from the network via the network interface; (b) for each of the data centers, allocating a plurality of data allocation percents of the service requests sequentially according to a schedule so as to receive a piece of electricity consumption information from each of the data centers and store the pieces of electricity consumption information into the storage; (c) creating a cost profile for each of the data centers according to the pieces of electricity consumption information; (d) determining an electricity load allocation percent of each of the data centers according to the cost profiles and the pieces of electricity charge information; and (e) allocating the subsequent service requests to the data centers according to the electricity load allocation percents.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts connection relationships among an electricity load management device 11, data centers C1, C2, . . . , Cn, a first network 10 and a second network 20 according to a first embodiment of the present invention;

FIG. 2 is a schematic view of the electricity load management device 11 according to the present invention; and

FIG. 3 is a flowchart diagram of an electricity load management method according to a second embodiment of the present invention.

### DETAILED DESCRIPTION

In the following description, the present invention will be explained with reference to example embodiments thereof. It should be appreciated that, these example embodiments are not intended to limit the present invention to any specific examples, embodiments, environment, applications or particular implementations described in these embodiments. Therefore, description of these example embodiments is only for purpose of illustration rather than to limit the present invention, and the scope of this application shall be governed by the appended claims. In addition, in the following embodiments and attached drawings, elements unrelated to the present invention are omitted from depiction; and dimensional relationships among the individual elements in the attached drawings are illustrated only for the ease of understanding, but not to limit the actual scale.

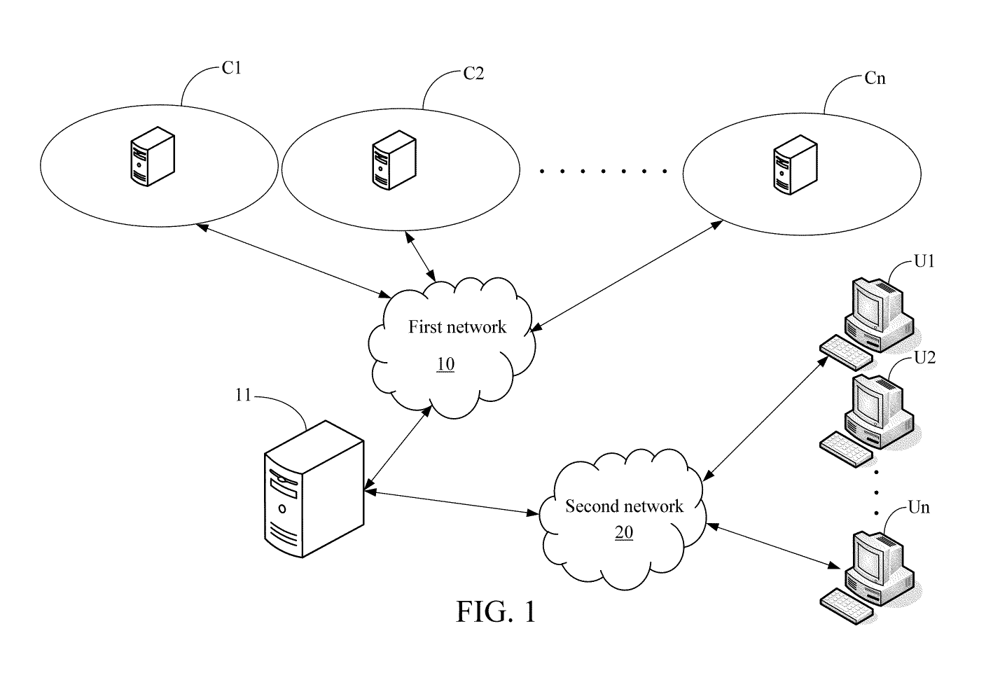

A first embodiment of the present invention is shown in FIG. 1. As shown in FIG. 1, an electricity load management device 11 of the present invention is connected to a plurality of data centers C1, C2, . . . , Cn via a first network 10 and receives a plurality of service requests (not shown) from a second network. The service requests are generated by at least one of a plurality of terminal devices U1, U2, . . . , Un and are transmitted to the electricity load management device 11 via a second network 20. The electricity load management device 11 of the present invention may be a portal server deployed by a network service provider, a routing device or any other device with the capability of allocating the service requests to the data centers C1, C2, . . . , Cn. The data centers C1, C2, . . . , Cn are deployed by the network service provider in one or more areas.

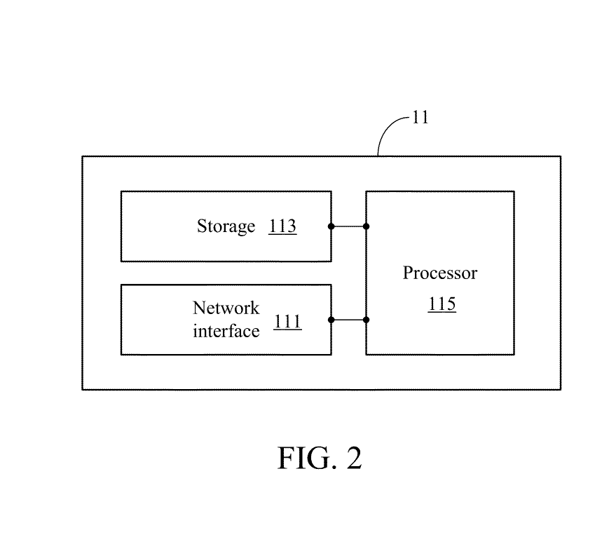

FIG. 2 is a schematic view of the electricity load management device 11 of the present invention. The electricity load management device 11 comprises a network interface 111, a storage 113 and a processor 115. The processor 115 is electrically connected to the network interface 111 and the storage 113. The network interface 111 is connected to the data centers C1, C2, . . . , Cn via the first network 10. The storage 113 records a piece of electricity charge information of each of the data centers C1, C2, . . . , Cn. Each of the pieces of electricity charge information comprises a basic electricity charge rate, an overuse extra charge and a QoS default penalty.

The processor 115 receives the service requests from the second network 20 via the network interface 111. Subsequently, for each of the data centers C1, C2, . . . , Cn, the processor 115 allocates a plurality of data allocation percents (e.g., 5%, 10%, 15%, 20%, . . . , and so on) of the service requests sequentially according to a schedule so as to receive a piece of electricity consumption information from each of the data centers and store the pieces of electricity consumption information into the storage 113.

For example, the aforesaid schedule may define a plurality of statistical intervals (for example, each statistical interval is two hours). For each of the data centers C1, C2, . . . , Cn, the processor 115 allocates one of the data allocation percents of the service requests continuously in each of the statistical intervals. Taking the data center C1 as an example, the processor 115 allocates 5% of the service requests to the data center C1 continuously within two hours (i.e., one statistical interval). Subsequently, the processor 115 allocates 10% of the service requests to the data center C1 continuously within the next 2 hours. Similarly, the processor 115 then allocates 15% of the service requests to the data center C1 continuously within another next two hours. In this way, the processor 115 can allocate all the data allocation percents of the service requests to the data center C1 successively through several statistical intervals.

Additionally, in the present invention, the data center C1 transmits the electricity consumption information in these statistical intervals to the electricity load management device 11 in response to the allocating operations of the electricity load management device 11 in these statistical intervals. The electricity consumption information comprises an electricity consumption power, an electricity consumption demand and a service response time. Subsequently, the processor 115 creates a cost profile for the data center C1 according to the electricity consumption information of the data center C1.

Specifically, for each of the data allocation percents, the processor 115 retrieves a maximum electricity consumption power, a minimum electricity consumption power, a maximum electricity consumption demand, a minimum electricity consumption demand, a longest service response time and a shortest service response time from the electricity consumption information of the data center C1 to create the cost profile. The cost profile is as shown in Table 1. As shown in Table 1, the service response time may (but is not limited to) be sub-divided into service response times of a plurality of service types.

| | Electricity | Electricity | | | |
|---|---|---|---|---|---|
| | consumption power | consumption demand | Service response time (seconds) | | |
| Data allocation | (KW) | in 15 minutes (KWH) | Maximum/Minimum | | |
| percent (%) | Maximum/Minimum | Maximum/Minimum | Type 1 | Type 2 | . . . |
| 5% | 500/1500 | 100/150 | 1/2 | 3/5 | . . . |
| 10% | 1400/2800 | 140/250 | 1.5/2.5 | 4/7 | . . . |
| 15% | 2500/4500 | 200/500 | 3/4 | 6/9 | . . . |
| . . . | . . . | . . . | . . . | | . . . |

After the cost profile of the date center C1 is created, the processor 115 continues to perform operations on the data center C2 as with the aforesaid data center C1 to create a cost profile for the data center C2. After cost profiles of all the data centers C1, C2, . . . , Cn are created, the processor 115 determines an electricity load allocation percent of each of the data centers C1, C2, . . . , Cn according to the cost profiles and the electricity charge information.

In detail, the electricity consumption-related cost considered in the present invention comprises the basic electricity charge, the overuse extra charge and the QoS default penalty. According to the maximum electricity consumption power and the minimum electricity consumption power in the cost profile, the processor 115 can determine whether the electricity consumption power used by each of the data centers C1, C2, . . . , Cn would exceed the maximum electricity consumption power specified in the contract signed with the electric power company under each of the data allocation percents. According to the maximum electricity consumption demand and the minimum electricity consumption demand in the cost profile, the processor 115 can determine whether the electricity consumption demand of each of the data centers C1, C2, . . . , Cn would exceed the maximum electricity consumption demand specified in the contract signed with the electric power company under each of the data allocation percents. Accordingly, the processor 115 can determine whether an overuse extra charge needs to be paid in cases where each data allocation percent of the service requests is processed by each of the data centers C1, C2, . . . , Cn.

Additionally, the processor 115 multiplies the maximum electricity consumption demand and the minimum electricity consumption demand in the cost profile respectively with the basic electricity charge rate in the electricity charge information to obtain the basic electricity charge corresponding to the cases where each of the data centers C1, C2, . . . , Cn processes each data allocation percent of the service requests. Moreover, according to the longest service response time and the shortest service response time of each service type in the cost profile, the processor 115 can determine whether a QoS default penalty needs to be paid in cases where each of the data centers C1, C2, . . . , Cn processes each data allocation percent of the service requests.

In this way, the processor 115 can obtain the electricity consumption-related cost in cases where each of the data centers C1, C2, . . . , Cn processes each data allocation percent of the service requests and determine an electricity load allocation percent of each of the data centers C1, C2, . . . , Cn accordingly. Then, the processor 115 allocates the subsequent service requests to the data centers C1, C2, . . . , Cn according to the electricity load allocation percents.

In other words, the processor 115 can obtain an overall electricity consumption-related cost under each allocation combination by estimating the electricity consumption-related cost for each of the data centers C1, C2, . . . , Cn to process each data allocation percent of the service requests, and select the allocation combination corresponding to the lowest overall electricity consumption-related cost as the electricity load allocation percents. Each of the electricity load allocation percents is one of the data allocation percents, and a sum value of the electricity load allocation percents is one hundred percent.

It should be appreciated that, the aforesaid numerical values of and the numbers of the statistical intervals and the data allocation percents are only for purpose of illustration. As can be appreciated by those of ordinary skill in the art based on the above explanation, the numerical values and the numbers of the statistical intervals and the data allocation percents may be defined according to practical operation conditions and are dependant on the expected accuracy of the overall electricity consumption-related cost estimated. For example, a longer statistical interval, a greater number of data allocation percents and a smaller spacing between the data allocation percents may lead to a more accurate overall electricity consumption-related cost estimated.

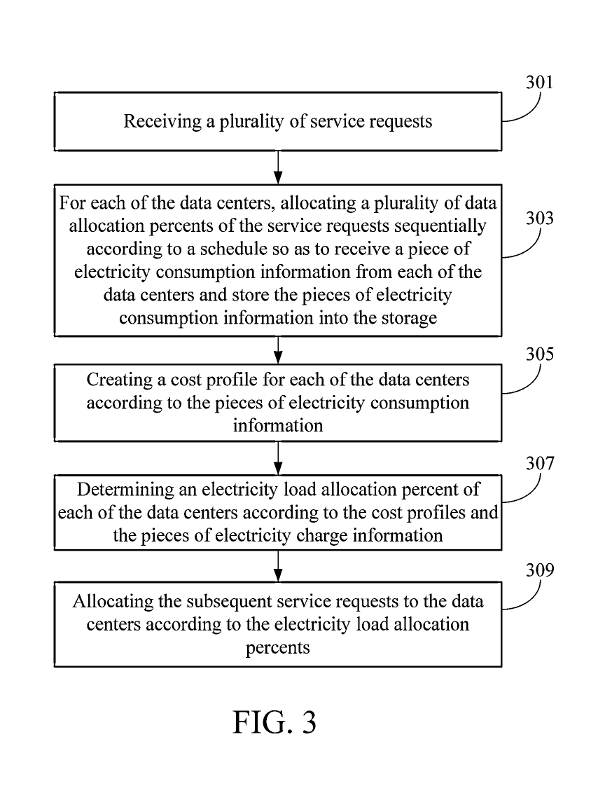

A second embodiment of the present invention is an electricity load management method, a flowchart diagram of which is shown in FIG. 3. The electricity load management method is adapted for use in an electricity load management device (e.g., the electricity load management device 11 of the first embodiment). The electricity load management device comprises a network interface, a storage and a processor. The network interface is connected to a plurality of data centers via a first network. The storage records a piece of electricity charge information of each of the data centers. Each of the pieces of electricity charge information comprises a basic electricity charge rate, an overuse extra charge and a QoS default penalty. The processor is electrically connected to the network interface and the storage and executes the electricity load management method.

Firstly, in step 301, a plurality of service requests is received from a second network via the network interface. Then, in step 303, a plurality of data allocation percents of the service requests are allocated sequentially according to a schedule for each of the data centers so as to receive a piece of electricity consumption information from each of the data centers and store the pieces of electricity consumption information into the storage. Subsequently, in step 305, a cost profile is created for each of the data centers according to the pieces of electricity consumption information. In step 307, an electricity load allocation percent of each of the data centers is determined according to the cost profiles and the pieces of electricity charge information. Finally, in step 309, the subsequent service requests are allocated to the data centers according to the electricity load allocation percents.

In addition to the aforesaid steps, the electricity load management method of this embodiment can also execute all the operations and functions set forth in the first embodiment. How this embodiment executes these operations and functions will be readily appreciated by those of ordinary skill in the art based on the explanation of the first embodiment, and thus will not be further described herein.

According to the above descriptions, the present invention provides an electricity load management mechanism. By adopting this electricity load management mechanism, the electricity load management device can make statistics on the electricity consumption information generated when a plurality of percents of service requests are processed by the data center so as to estimate the basic electricity charge, the overuse extra charge and the QoS default penalty. Finally, the electricity load management device determines how many percents of the service requests are allocated to each of the data centers according to the estimation results. Accordingly, the electricity consumption-related cost of the entire data center can be controlled effectively.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electricity load management device, comprising:
a network interface connected to a plurality of data centers via a first network;
a storage, being configured to record a piece of electricity charge information of each of the data centers, wherein each of the pieces of electricity charge information comprises a basic electricity charge rate, an overuse extra charge and a quality of service (QoS) default penalty; and
a processor electrically connected to the network interface and the storage, being configured to execute the following steps of:
(a) receiving a plurality of service requests from a second network via the network interface;
(b) for each of the data centers, allocating a plurality of data allocation percents of the service requests sequentially according to a schedule so as to receive a piece of electricity consumption information from each of the data centers and store the pieces of electricity consumption information into the storage;
(c) creating a cost profile for each of the data centers according to the pieces of electricity consumption information;
(d) determining an electricity load allocation percent of each of the data centers according to the cost profiles and the pieces of electricity charge information; and
(e) allocating the subsequent service requests to the data centers according to the electricity load allocation percents.

2. The electricity load management device as claimed in claim 1, wherein each of the pieces of electricity consumption information compromises an electricity consumption power, an electricity consumption demand and a service response time.

3. The electricity load management device as claimed in claim 2, wherein for each of the data centers, the step (c) further comprises the following step of:
retrieving a maximum electricity consumption power, a minimum electricity consumption power, a maximum electricity consumption demand, a minimum electricity consumption demand, a longest service response time and a shortest service response time from the piece of electricity consumption information to create the cost profile.

4. The electricity load management device as claimed in claim 1, wherein the schedule defines a plurality of statistical intervals and for each of the data centers, the step (b) further compromises the following step of:
allocating one of the data allocation percents of the service requests continuously in each of the statistical intervals.

5. The electricity load management device as claimed in claim 1, wherein each of the electricity load allocation percents is one of the data allocation percents, and a sum value of the electricity load allocation percents is one hundred percent.

6. An electricity load management method for use in an electricity load management device, wherein the electricity load management device comprises a network interface, a storage and a processor, the network interface is connected to a plurality of data centers via a first network, the storage records a piece of electricity charge information of each of the data centers, each of the pieces of electricity charge information comprises a basic electricity charge rate, an overuse extra charge and a QoS default penalty, the processor is electrically connected to the network interface and the storage, and the electricity load management method is executed by the processor and comprises the steps of:
(a) receiving a plurality of service requests from a second network via the network interface;
(b) for each of the data centers, allocating a plurality of data allocation percents of the service requests sequentially according to a schedule so as to receive a piece of electricity consumption information from each of the data centers and store the pieces of electricity consumption information into the storage;
(c) creating a cost profile for each of the data centers according to the pieces of electricity consumption information;
(d) determining an electricity load allocation percent of each of the data centers according to the cost profiles and the pieces of electricity charge information; and
(e) allocating the subsequent service requests to the data centers according to the electricity load allocation percents.

7. The electricity load management method as claimed in claim 6, wherein each of the pieces of electricity consumption information compromises an electricity consumption power, an electricity consumption demand and a service response time.

8. The electricity load management method as claimed in claim 7, wherein for each of the data centers, the step (c) further comprises:
retrieving a maximum electricity consumption power, a minimum electricity consumption power, a maximum electricity consumption demand, a minimum electricity consumption demand, a longest service response time and a shortest service response time from the piece of electricity consumption information to create the cost profile.

9. The electricity load management method as claimed in claim 6, wherein the schedule defines a plurality of statistical intervals and for each of the data centers, the step (b) further compromises:
allocating one of the data allocation percents of the service requests continuously in each of the statistical intervals.

10. The electricity load management method as claimed in claim 6, wherein each of the electricity load allocation percents is one of the data allocation percents, and a sum value of the electricity load allocation percents is one hundred percent.
